(19) United States
(12) Patent Application Publication
(10) Pub. No.: US 2016/0029577 A1
(43) Pub. Date: Feb. 4, 2016

(54) Elevated Irrigation Mounting System

(71) Applicant: Toby Brashear, Punta Gorda, FL (US)

(72) Inventor: Toby Brashear, Punta Gorda, FL (US)

(21) Appl. No.: 14/665,215

(22) Filed: Mar. 23, 2015

Related U.S. Application Data
(63) Continuation-in-part of application No. 13/694,002, filed on Oct. 19, 2012, now abandoned.
(60) Provisional application No. 61/627,899, filed on Oct. 20, 2011.

(51) Int. Cl. A01G 25/00; F16K 27/00

(52) U.S. Cl. CPC A01G 25/00; F16K 27/003

(57) ABSTRACT

An elevated irrigation mounting system is mounted in any location desired by the user, or due to system constraints, which utilizes quick disconnects, for ease of installation or moving to another location. The system centralizes all of the control valves, wiring, and includes the irrigation control unit of the elevated irrigation mounting system in one location for mounting on an elevated surface, thus ensuring ease of installation, maintenance, system trouble shooting, winterizing and system zone control. The control valves of the system are controlled by a control unit which Is electrically and cooperatively engaged but may also be controlled by digital means. Also, the elevated irrigation mounting system is accessible for repairs, calibration or maintenance while the owner is away, enabling the maintenance technician to perform all maintenance functions inconveniencing the owner by requiring home or building access.

### CROSS-REFERENCE TO RELATED APPLICATIONS

This patent application is related to and claims priority to U.S. Provisional Application No. 61/627,899, entitled “Remotely Mounted Irrigation Control System,” by Toby Brashear, filed on Oct. 20, 2011, and is a Continuation-in-Part to U.S. patent application Ser. No. 13/694,002, entitled “Remotely Mounted Irrigation Control System,” by Toby Brashear, filed on Oct. 19, 2012.

### FIELD OF USE

The present invention relates to an elevated irrigation mounting system, wherein the control valves, wiring harness, and irrigation control unit, are mounted in a weather proof box, with a removable enclosure, said enclosure having a door and a notched manifold bracket or a manifold hanger and a notched cover, said enclosure being mounted to any preferred surface, be it the side of a building, tree, pole, or other mounting point. The irrigation control unit of the present invention may also be remotely controlled via computer, laptop, smartphone, or tablet.

### BACKGROUND OF THE INVENTION

Prior approaches to irrigation control typically have the control valves and associated hardware buried underground near the sprinkler head with said control valve controls. This is undesirable as installation, maintenance, and purging the system for winterizing are more labor intensive and costly.

Some prior art irrigation control units include:
U.S. application Ser. No. 07/124,722 (Bayat) discloses a self-contained, automated flow control system for use in a water distribution system such as a sprinkler system. The system has a master valve which controls communication between a supply line and a manifold, and a plurality of control valves which control communication between the manifold and a plurality of outlet lines. An anti-siphon valve is connected between the master valve and the control valves to prevent water from being drawn back into the supply line from the outlet lines. Operation of the master valve and control valves is controlled by a clock timer which is programmed to actuate the valves in a predetermined sequence and to open the master valve only when one of the control valves is open.
U.S. Pat. No. 5,238,017 (Andersson et al.) discloses a valve connection array for mounting at a cabinet wall in a sealed cabinet for disposing a plurality of valve connection blocks in at least one row is disclosed. Each valve connection block includes a valve connection portion on a front surface for individually connecting a valve and associated connections ports on a rear surface for connecting pressurized medium conduits. At least one row of valve connection blocks define between opposite side surfaces thereof at least one inlet port and at least one outlet port for providing common inlet and outlet ports between juxtaposed valve connection blocks. The blocks include means for mounting the blocks in said row with said sides sealingly juxtaposed for defining said common inlet and outlet ports between blocks and with said blocks defining a common flat surface area substantially in the form of a rectangle around said row. The row of blocks is mounted into a cabinet in a rectangular opening in the cabinet wall to dispose the valve connection portions inside the cabinet and said connection ports outside the cabinet, with the rectangular flat surface area sealingly engaging an edge portion of said cabinet wall defining the opening. First and second end members are mounted to the block array for closing the common inlet and outlet ports of said valve connection block array.
U.S. Pat. No. 6,834,662 (Olson et al.) discloses an improved automated sprinkler system. A pre-assembled housing or valve box includes an inlet for receiving water and one or more outlets for the distribution of water to other components in the irrigation system, and also includes manifold and power and valve means for selectively controls the flow of water from the outlets. Many of the manifold components are integrally molded with each other and provided in modular form so that the system can be relatively compact and can be customized into a variety of configurations. The manifold includes integrally formed or interconnected valve bases.
U.S. Publication No. 2007027230 (Schumacher) discloses an irrigation system valve manifold vault for subsurface installation and maintenance. The inventive apparatus provides a secure enclosure to prevent migration of the vault within and along the ground and that protects irrigation valves and valve components from water, contamination by dirt and debris, chemical damage from soils, insect infestation, and damage from impact and weather. In a first preferred embodiment, the inventive apparatus comprises a generally rectangular support base, a vault truncated, four-side pyramidal vault enclosure mounted on the support base, an openable lid removably or attached by hinges to the top of the vault enclosure for access to the interior in which a valve manifold is contained, and attachment means for mounting a water supply pipe or other component of the valve assembly onto the side or top surface of the support base.

One object of the irrigation control system of the present invention is a manifold system comprising control valves, mounted in a wall mountable unit with the manifold and manifold bracket constructed in such a manner so as to enable enough space for valves to be replaced individually without any interference from the valves or tubing on either side with a complete 180 degree rotation capability if required. In addition, any size valve may be used depending on the required specifications.

Another objective of the remotely mounted irrigation control unit of the present invention is to enable the valves and controller to be prewired with a specific wiring harness that uses weather proof or non-weather proof connectors and specific wiring protection and covering, such as convoluted conduit. The wiring harness is located in the manifold for protection and routing.

Yet another object of the elevated irrigation mounting system of the present invention is weather proof, remotely mountable, control box whereby said control valves, manifold, and irrigation control are placed inside.

In addition, the elevated irrigation mounting system of the present invention relates to the control being accessible for repairs, calibration or maintenance while the owner is not home, enabling the maintenance technician to be able to perform any of the previously mentioned functions without inconveniencing the owner by requiring the owner to come home from work or other activities.

What is needed is a remotely mountable elevated irrigation mounting system wherein installation, maintenance, system trouble shooting, winterizing and system zone control is more easily performed. This system is designed to accept any size valve, pipe, and controller from any manufacturer. For example, any 1″ valve with female threads on the intake and discharge may be used, enabling cost to be minimized while simplifying maintenance and increasing valve life as the effects of being buried underground are eliminated, thus enabling the installer to provide a longer warranty.

Lastly, what is needed is an irrigation control unit which may be remotely accessed via personal computer or smart phone, enabling the user to program zone watering and duration and to monitor system performance, such as fluid consumption, power consumption, and individual valve performance.

### SUMMARY OF THE INVENTION

The remote mountable irrigation control unit of the present invention addresses these objectives and these needs.

The remote mountable irrigation control unit of the present invention is compatible with essentially any size valve, pipe, and any controller. It is further designed to accept valves, pipes and controllers from any manufacturer. The manifold bracket, for each version and size of enclosure, is designed with a notch at the top, back edge of the bracket the notch enabling a lift-off cover to be used without a door. This is for the low cost version of enclosure but is preferably present on all manifolds even when the enclosure, with a door, is used. The lift-off cover enables shrubs or bushes to be planted nearby the enclosure while still enabling access to the irrigation components for service, repair, or the installation of new parts. The bottom of the closeout cover is designed with slots or notches to enable the pipes to enter and exit the enclosure while keeping small animals out of the enclosure.

The elevated irrigation mounting system enables the installer to provide a longer warranty to the customer. Prior approaches have the sprinkler head control valves buried underground near the sprinkler head which is being controlled. This is undesirable as maintenance and system trouble shooting is very difficult, requiring much more work than the object of present invention. In addition, the amount of wiring necessary between the zone timer and control valve is greatly reduced. There is the added bonus of the prevention of burrowing animals from wreaking havoc on the system by chewing through the wiring and causing failures which can require a fair amount of trouble shooting to discover. The control valves are preferably attached to the manifold assembly via a quick disconnect coupler so as to facilitate quick changes of the control valves if any fail or to install a straight pipe if such a change were necessary due to changes in irrigation specifications.

The remote mountable irrigation control unit includes said weather-proof box, manifold, control valves, quick disconnect couplers, and irrigation control unit. The present invention is assembled and affixed to whichever surface is preferable given a particular installation, which in many cases will be the side of a building or domicile or even a pole.

The elevated irrigation mounting system of the present invention can be mounted in any location desired by the user, or due to system constraints, which utilizes quick disconnects, for ease of installation or moving to another location. The preferred embodiment of the present invention centralizes all of an irrigation systems control valves, wiring, and includes the irrigation control unit, thus ensuring ease of maintenance and installation. The unit may be controllable via personal computer, laptop, or smart phone, enabling the user to program all aspects of the system, from zone irrigation duration, to which zones receive irrigation at what time, and observe system performance such as power consumption, fluid consumption, and determine if there are any leaks in the system via pressure drops sensed at one of the valves. This software enables the user to manually turn off individual valves in the case of leaks or sprinkler head failure.

For a complete elevated irrigation mounting system of the present invention, reference is made to the following summary of the invention detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention.

### BRIEF DESCRIPTION OF THE DRAWINGS

FIG. 1 depicts an assembly view of a first preferred embodiment of the elevated irrigation mounting system of the present invention, the elevated irrigation mounting system including a manifold, a manifold bracket, a control unit, and PVC tubing for mounting in an enclosure and secured onto an exterior wall.

FIG. 2 depicts the first preferred embodiment of the elevated irrigation mounting system shown in FIG. 1, with the enclosure assembled and covering the manifold, a manifold bracket, a control unit, and PVC tubing for mounting onto the exterior wall.

FIG. 3 depicts a second preferred embodiment of the elevated irrigation mounting system of the present invention, the elevated irrigation mounting system including a manifold, a manifold bracket, a control unit, and PVC tubing for mounting in an enclosure, the enclosure and the manifold bracket each including mounting flanges to enable mounting said components onto an exterior wall.

FIG. 4A depicts the elevated irrigation mounting system of FIG. 3 with the control valve assembly, the control unit, and PVC plumbing, installed in the weather-proof enclosure; FIG. 4B depicts the elevated irrigation mounting system of FIG. 4A minus the control unit; FIG. 4C depicts the elevated irrigation mounting system of FIG. 3 from the front view wherein the manifold bracket, and control unit are visible; FIG. 4D depicts a partial sectional view of the elevated irrigation mounting system of FIG. 3 from the top view wherein the control valve assembly, PVC plumbing and manifold bracket are visible and the system is mounted onto an exterior wall; and FIG. 4E depicts the front view of the elevated irrigation mounting system of the enclosure FIG. 3 without the door.

FIG. 5A depicts the rear view of the elevated irrigation mounting system of FIG. 3 with the door open and the latch visible; FIG. 5B depicts the side view of the elevated irrigation mounting system of FIG. 3 wherein the enclosure in the open position; FIG. 5C depicts the side view of the elevated irrigation mounting system of FIG. 3 with the enclosure in the closed position; and FIG. 5D depicts the rear view of an alternative embodiment of the elevated irrigation mounting system of the present invention wherein an opposing side view of FIG. 5C includes an opening for a lift-off cover.

FIG. 6A depicts an exploded front view of the manifold bracket for use with the elevated irrigation mounting system of FIG. 3, in a scaled down of the control valve, and manifold bracket; FIG. 6B depicts an exploded top view of the elevated irrigation mounting system of FIG. 3, in a scaled down version of the control valve, and manifold bracket; and FIG. 6C depicts an exploded top view of the elevated irrigation mounting system of FIG. 3, in a scaled down version of the control valve, and the manifold.

FIG. 7A depicts a first end view of the manifold bracket of the elevated irrigation mounting system of FIG. 3, depicting the notch needed for mounting on an exterior surface; FIG. 7B depicts the top view of the manifold bracket of FIG. 7A; FIG. 7C depicts the other end view of the manifold bracket of FIG. 7A; FIG. 7D depicts the front view of the manifold bracket of FIG. 7A; FIG. 7E depicts a first sectional view A-A through FIG. 7B; and FIG. 7F depicts a second sectional view B-B through FIG. 7B.

FIG. 8 depicts yet another preferred embodiment of the elevated irrigation mounting system of the present invention, including a manifold hanger including convoluted tubing electrically engaged with the wire bundle between the control unit and the plurality of control valves.

FIG. 9 depicts still yet another preferred embodiment of the elevated irrigation mounting system of the present invention with the irrigation control unit electrically engaged with a primary irrigation system and a secondary irrigation system with is common in installations where the size of the unit grows beyond initial capacity.

FIG. 10 depicts assembly view of the elevated irrigation mounting system unit of FIG. 1 mounted onto an exterior wall of a residence.

FIG. 11 depicts assembly view of the elevated irrigation mounting system unit of FIG. 9 mounted onto an exterior wall of a residence, the irrigation control unit not being shown.

### DETAILED DESCRIPTION OF THE PREFERRED EMBODIMENTS

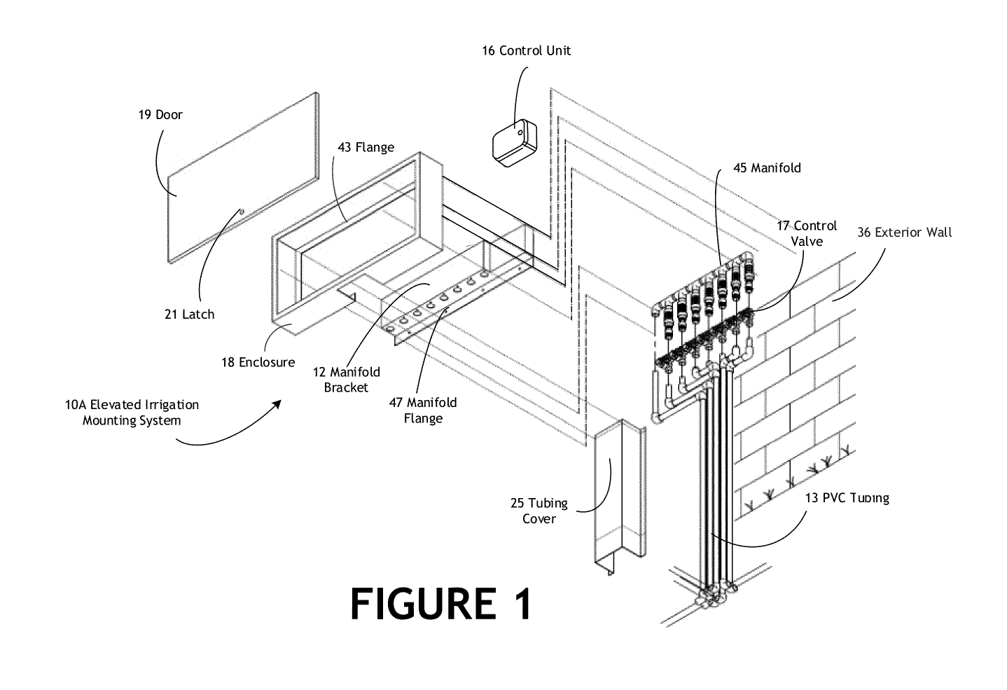

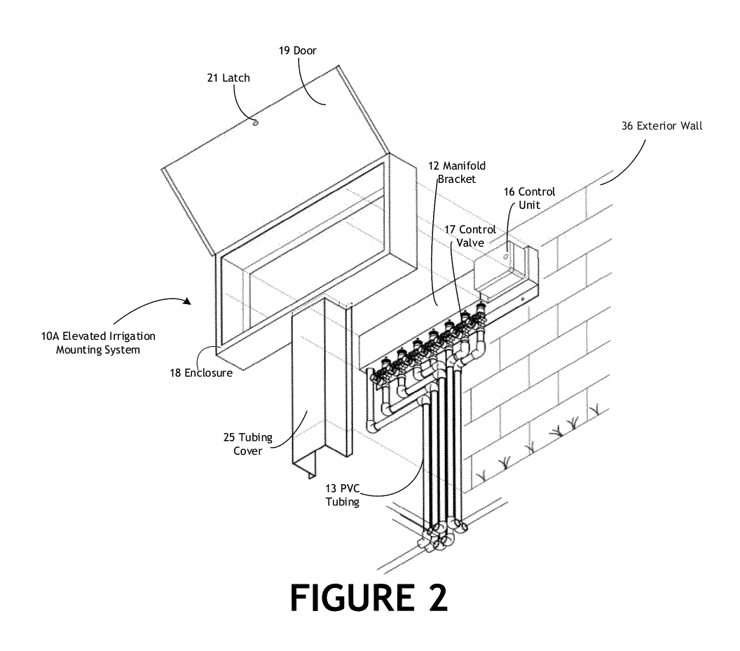

Referring to the drawings, FIGS. 1 and 2 depict a first preferred embodiment of an assembly view of the elevated irrigation mounting system of the present invention [10A]. In this view, the manifold [45], PVC tubing [13], control valves [17], manifold bracket [12], tubing cover [25], control unit [16], enclosure [18], door [19], and latch [21] are clearly visible. FIG. 2 also depicts an isometric view of the remotely mounted irrigation control unit [10] of the present invention but with the enclosure [18] assembled for attachment an exterior wall [36]. The tubing cover [25] is secured to the enclosure [18], covering the PVC tubing [13] and sealing the enclosure [18] preventing anything from crawling into the enclosure [18] as well as protecting the PVC tubing [13] from any flying debris which may be kicked up by a lawnmower other errant flying objects as well as providing some protection from the elements.

The enclosure [18] preferably includes an enclosure flange [43] which substantially surrounds the inside perimeter of the enclosure [18]. The enclosure flange [43] extends inwardly and preferably includes a plurality of mounting apertures to secure said elevated irrigation mounting system of the present invention [10A] to an exterior wall [36]. The manifold bracket may also preferably include a mounting flange [47] and a plurality of mounting apertures to secure said elevated irrigation mounting system of the present invention [10A] to an exterior wall [36]. While it is preferred that said elevated irrigation mounting system of the present invention [10A] includes both the enclosure flange [43] with mounting apertures and the manifold bracket flange [47}, in many applications only one may be needed.

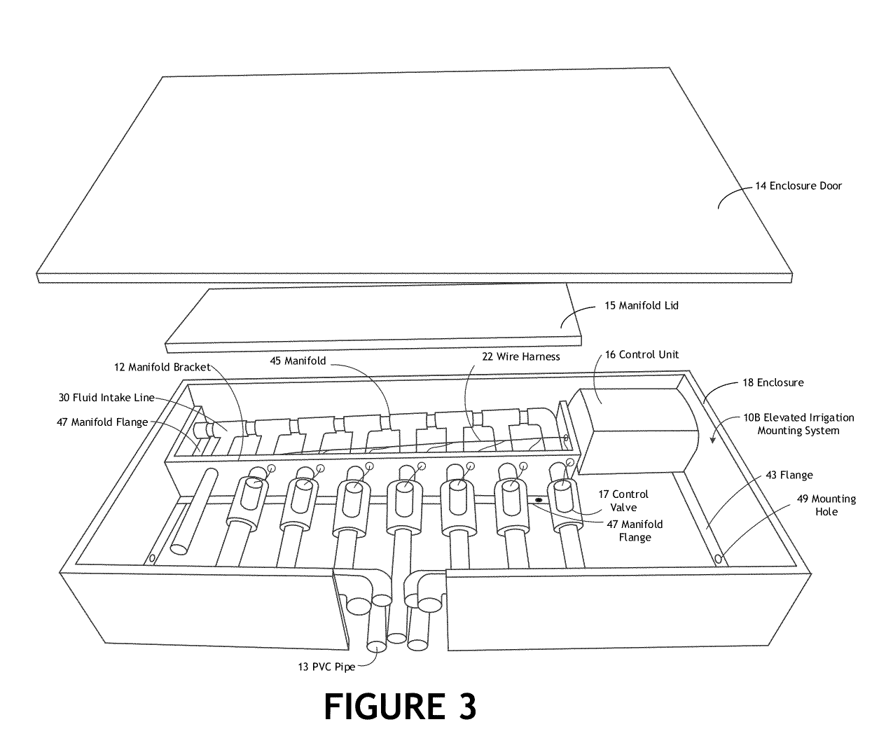

FIG. 3 depicts a second preferred embodiment of the elevated irrigation mounting system of the present invention [10B], including irrigation control valves [17], the manifold bracket [12], PVC tubing [13], and the control unit [16]. As is seen, the unit is modular in construction and individual irrigation control valves [17] can be added or deleted depending on the needs of a particular application.

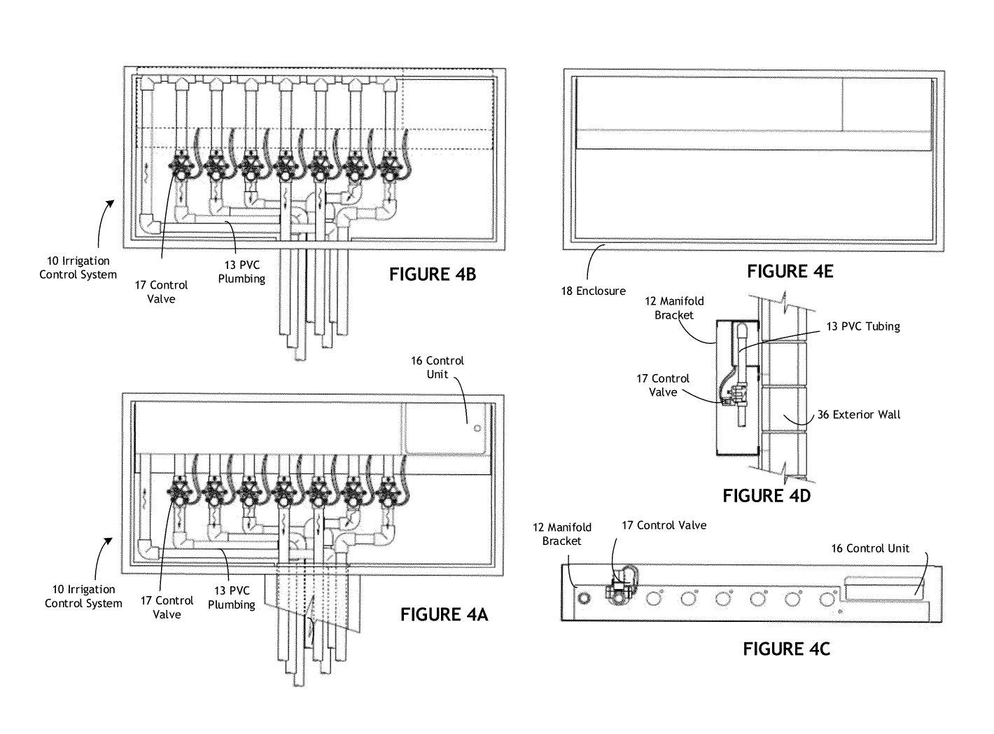

FIG. 4A depicts the elevated irrigation mounting system [10B] of FIG. 3 with the control valve assembly [17], the control unit [16], and PVC plumbing [13], installed into the weather proof box. FIG. 4B depicts the preferred embodiment of the elevated irrigation mounting system [10B], with control valve assembly [17], and PVC plumbing [13], installed in the weather proof box minus the control unit; FIG. 4C depicts the elevated irrigation mounting system of FIG. 3 from the front view wherein the manifold bracket [12], and control unit [16] are visible. FIG. 4D depicts the elevated irrigation mounting system [10B] from the top view wherein the control valve assembly [17], the PVC plumbing [13] and manifold bracket [12] being plainly visible. FIG. 2E depicts the preferred embodiment of the elevated irrigation mounting system of the enclosure FIG. 3 without the door.

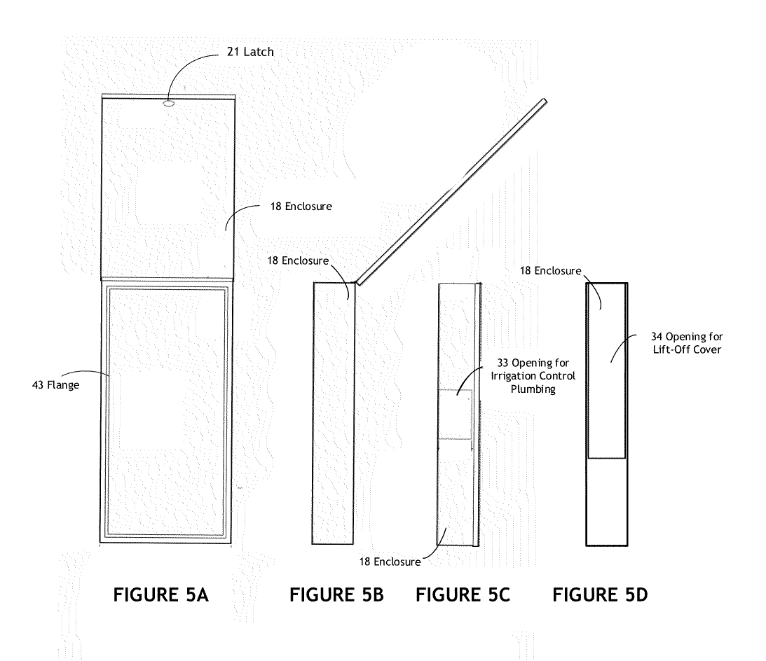

FIGS. 5A through 5C disclose the preferred embodiment of the enclosure [18] for use with the elevated irrigation mounting system [10B] of the present invention. The front of the irrigation control unit comprises a weather proof door [19], while located inside of the unit are mounted the irrigation control valves [17], irrigation control unit [16], manifold bracket [12] and PVC tubing [13] said control valves [17] are affixed to. FIGS. 5A, and 5B, depict the rear and side view of the preferred embodiment of the present invention with the weather proof door assembly, comprising the door [19] and latch [18] in the open position while FIG. 5C depicts the preferred embodiment of the present invention from the side view with the weather proof door assembly, comprising the door [19] and latch [18] closed and the opening for the irrigation control unit plumbing [20]. The enclosure [18] preferably includes an enclosure flange [43] which substantially surrounds the inside perimeter of the enclosure [18]. The enclosure flange [43] extends inwardly and preferably includes a plurality of mounting apertures to secure said elevated irrigation mounting system of the present invention [10A] to an exterior wall [36]. Once the unit is assembled and mounted in the preferred position, all aspects of irrigation will be controllable from said unit. Everything from setting individual zone control, being able to diagnose failed/failing control valves and leaks associated with improper valve installation from one location instead of having to dig up every valve to trouble shoot failures or leaks. FIG. 5D depicts the rear view of an alternative embodiment of the elevated irrigation mounting system of the present invention wherein an opposing side view of FIG. 5C includes an opening [34] for a lift-off cover.

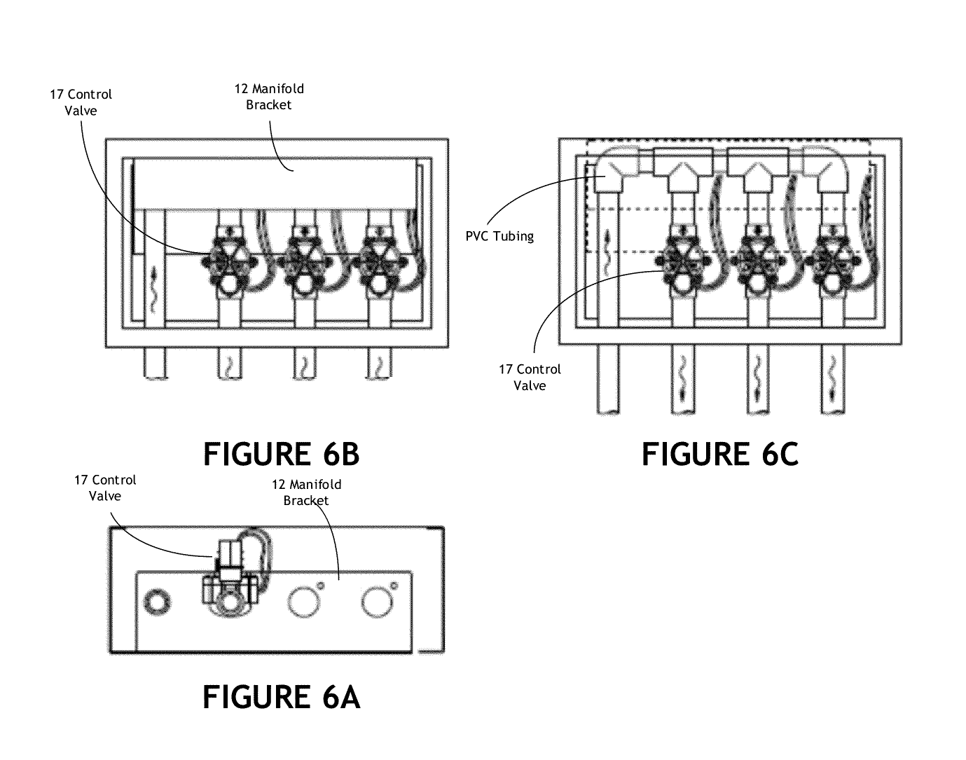

FIG. 6A depicts an exploded front view of the manifold bracket for use with the elevated irrigation mounting system [10B], no control valve being shown. FIG. 6B depicts an exploded top view of the elevated irrigation mounting system [10B], in a scaled down version of the control valve, and manifold bracket; and FIG. 6C depicts an exploded top view of the elevated irrigation mounting system [10B], in a scaled down version of the control valve, and the manifold. This enables the unit to be transferred from one location to another via the use of quick disconnects, enabling the unit to be disconnected from one set of sprinklers and be moved to a new location and quickly connected. This saves considerable time, and money as a user can simply move the unit to a new location if a given area has been irrigated and another area now needs irrigation. This saves enormous setup and assembly cost as the existing unit can be plugged in and the zones reprogrammed.

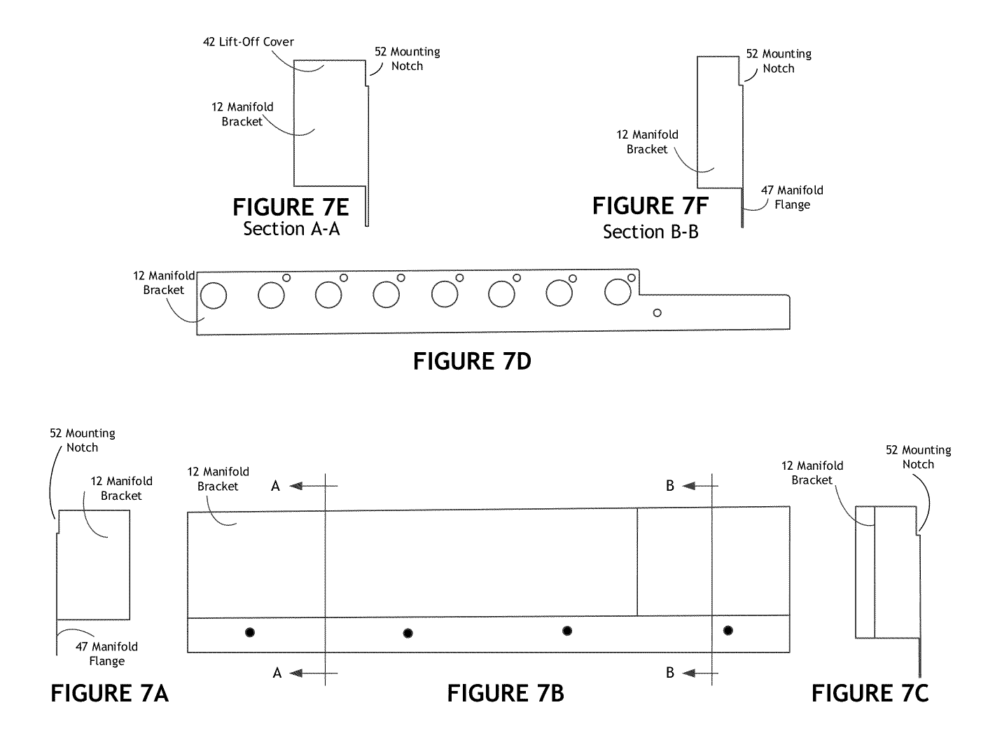

FIG. 7A depicts the top view of the manifold bracket [12] depicting the notch needed for installation. When the manifold bracket [12] is open, the mounting notch [52] includes a plurality of mounting apertures on the bottom surface of the mounting bracket [12]. The manifold bracket is positioned along the upper portion of the enclosure. The enclosure flange preferably surrounds the bottom of the perimeter of the enclosure [18]. The aperture holes in the mounting bracket flange [47] are aligned with the aperture holes in the enclosure flange [43] enabling a secure mount onto an exterior surface [36]. FIG. 7B depicts the front view of the manifold bracket [12]. FIG. 7C depicts the bottom view of the manifold bracket [12]. FIG. 7D depicts the end view of the manifold bracket [12]. FIG. 7E depicts a section view through the upper portion of FIG. 7B, and FIG. 7F depicts a section view through the lower portion of FIG. 7B.

FIG. 7E also depicts the lift-off cover [42]. The manifold bracket [12] for each version and size of enclosure [18], is designed with a notch [52] at the top, back edge of the manifold bracket [12] the notch [52] enabling a lift-off cover [42] to be used without a door. This is for a low cost version of enclosure [18] but is preferably present on all manifolds bracket [12] even when the enclosure [18] with a door [19] is used. The lift-off cover [42] enables shrubs or bushes to be planted nearby the enclosure [18] while still enabling access to the irrigation components for service, repair, or the installation of new parts.

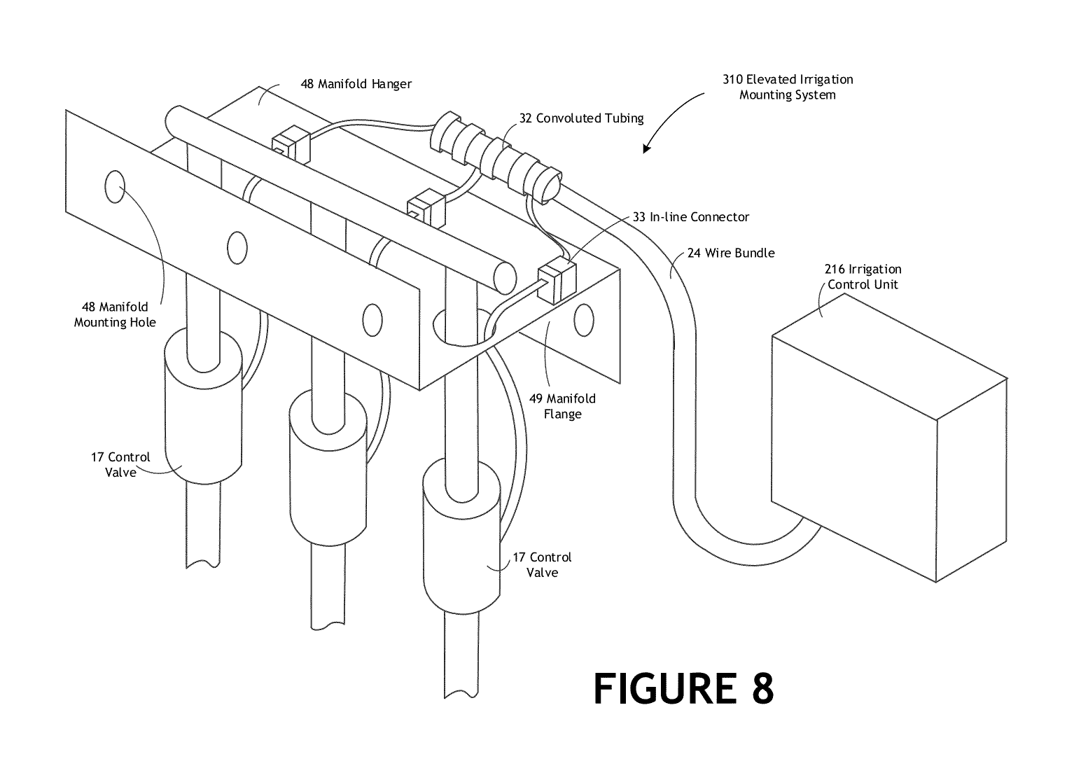

FIG. 8 depicts yet another preferred embodiment of the elevated irrigation mounting system of the present invention, including a manifold hanger [48] and convoluted tubing electrically engaged with the wire bundle between the control unit and the plurality of control valves.

The manifold hanger [48] has a Z-shaped profile and includes openings for the PVC tubing feeding the control valves, the openings being so spaced so as to enable individual control valves to be replaced without interfering with adjacent valves or tubing on either side. The wire bundle [24] feeds into convoluted tubing [32] and eventually to each control valve [17]. The manifold hanger [48] is preferably positioned along the upper portion of the enclosure, the enclosure flange preferably surrounding the bottom of the perimeter of the enclosure [18]. The aperture holes in the mounting bracket flange [47] of the manifold hanger [48] are aligned with the aperture holes in the enclosure flange [43] enabling a secure mount onto an exterior surface [36]. This is but one of the preferred methods of installation and can be altered depending on customer needs, such as adding more control valves [17] or reducing the number of control valves [17].

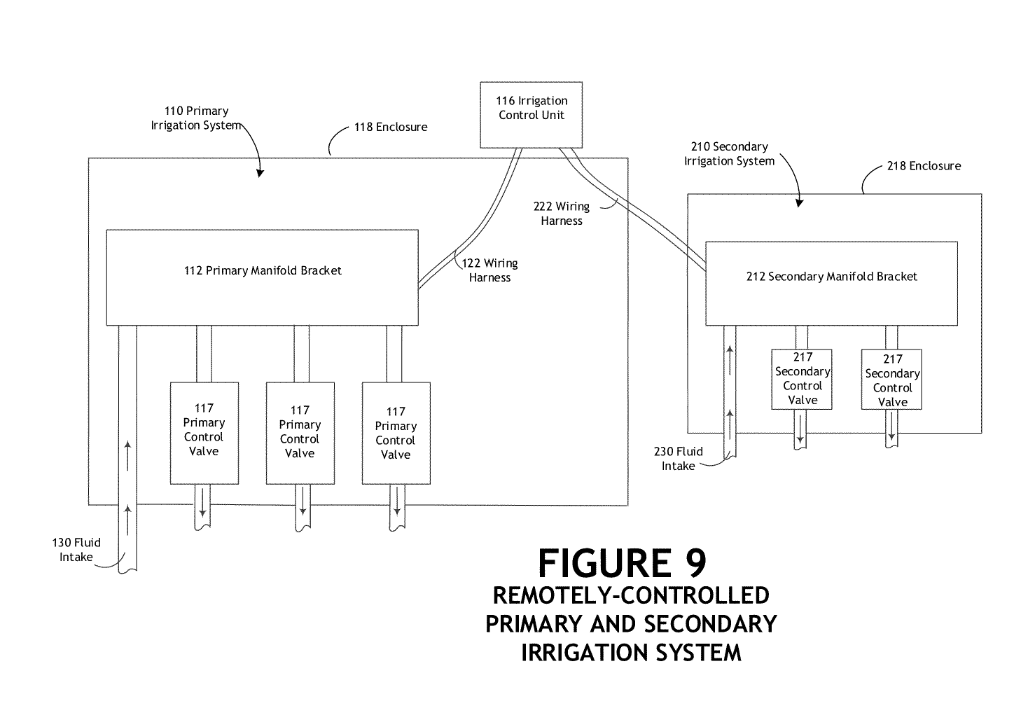

FIG. 9 depicts yet another preferred embodiment of the elevated irrigation mounting system of the present invention, including a primary and secondary irrigation systems [110 and 210]. The system includes a fluid intake pipe [130 and 230] feeding into the primary and secondary irrigation systems [110 and 210] combination. The complete secondary irrigation control unit [210] with the layout of the primary control valves [117] in relation to the primary manifold [112] with the addition of a secondary irrigation control unit [210], and wiring [122 and 222] used to connect the secondary irrigation control unit [210], which will act as a backup in case the first unit fails, or in case additional capacity is needed for additional sprinkler units. The fluid intake [230] is also showing here with fluid flowing up into the PVC pipe and down through the secondary control valves [217] and to the sprinkler heads (not shown). The irrigation control unit [116] is either positioned inside enclosure [118] of the primary irrigation system [110] or external to both the primary and secondary irrigation systems [110 and 210], while either electrical or digitally engaged with primary and secondary control valves [127 and 217] by wiring harnesses [122 and 222, respectively] or by digital means.

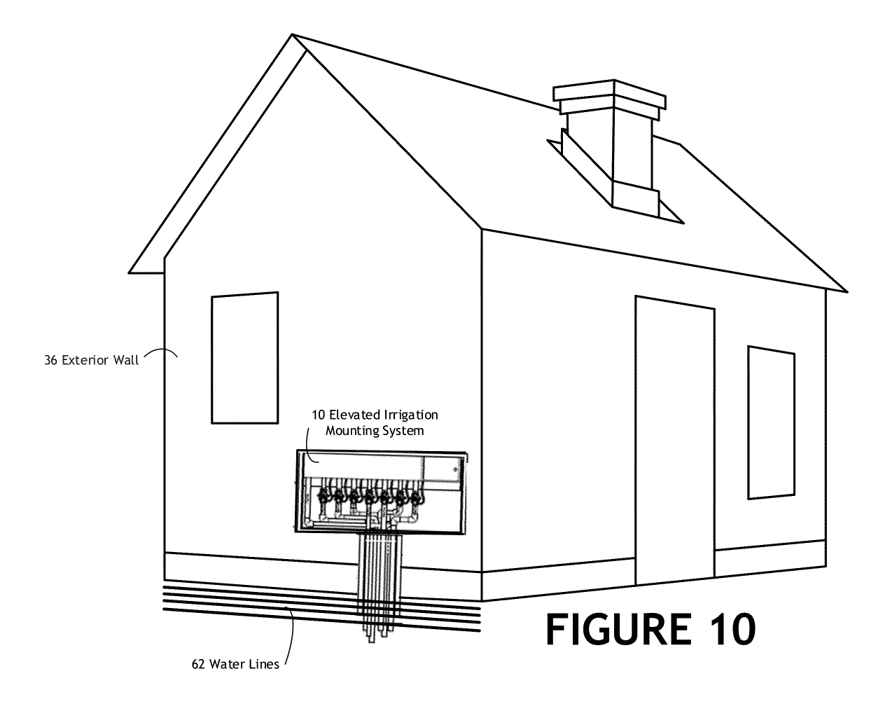

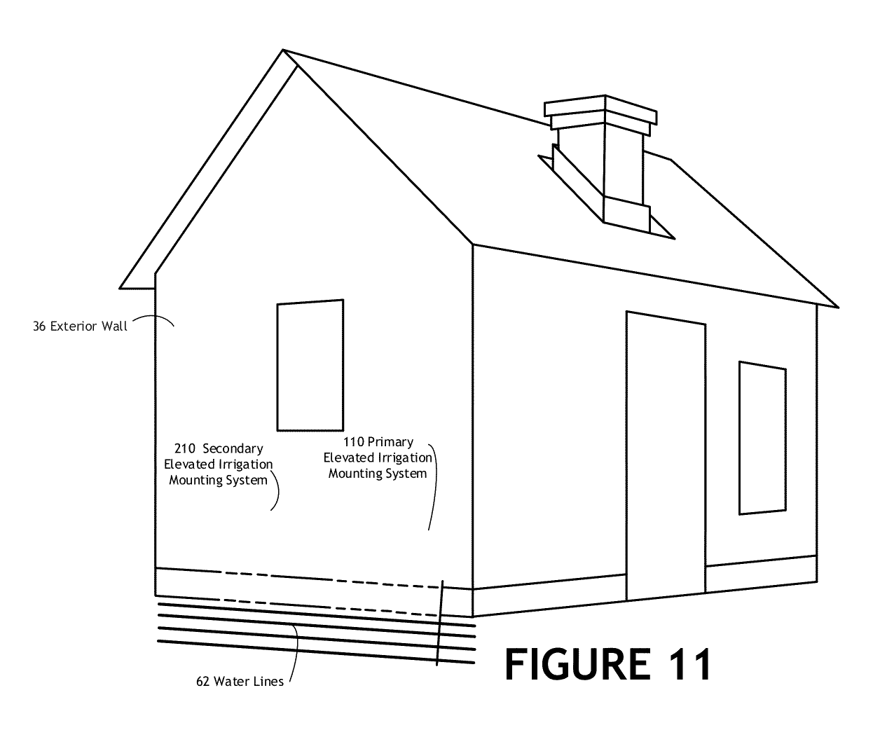

FIG. 10 depicts the elevated irrigation mounting system of the present invention [10] mounted onto an exterior wall [36] of a residence controlling fluid flow in lines [62]. FIG. 11 depicts a primary irrigation system of the present invention [10] and a secondary irrigation unit [210] mounted onto an exterior wall [36] of a residence controlling fluid flow in lines [62]. The irrigation control unit [116] depicted in FIG. 9 is not shown.

Installation time and cost are greatly reduced since the unit can be pre-assembled off-site to a customer's specifications. Winterizing of the present invention is greatly eased as purging of the valves is insured since they are above ground and easily accessed. Also, much less wiring is used as a result of the valves and control unit being centrally located which will increase system reliability by having less wiring underground susceptibility to animals and wear and tear caused by exposure to elements and grounds maintenance.

The enclosure and all of its components can be made out of a variety of materials including, but not limited to, steel, aluminum, fiberglass, plastic, and wood.

Another embodiment involves the control unit itself, which having the ability to be accessed remotely, via the cloud, enabling a user to remotely program the zone irrigation and irrigation duration via computer, smart phone, and tablet. Alerts may also be setup to alert the user to fluid usage, and problems with the system, for example a pressure drop in a given valve indicating the possibility of a leak at a given sprinkler head. This enables the user to turn off individual control valves, preventing the geysers one sees when a sprinkler head has failed, and preventing the fluid from flowing through a ruptured portion of irrigation line, potentially ruining the turf, or garden or other area being irrigation.

Throughout this specification, various patents are referenced by application number and inventor. The disclosures of these patents are hereby incorporated by reference in their entireties into this specification in order to more fully describe the state-of-the-art.

It is evident that many alternatives, modifications, and variations of the elevated irrigation mounting system of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

### PARTS LIST

10A. Elevated Irrigation Mounting System—1^{st} Embodiment
10B. Elevated Irrigation Mounting System—2^{nd} Embodiment
12. Manifold Bracket
13. PVC Tubing
14. Enclosure Lid
15. Manifold Lid
16. Control Unit
17. Control Valve
18. Enclosure
19. Door
20. Convoluted Tubing
21. Latch
22. Wire Harness
23. In-line Connector
24. Wire Bundle
25. Tubing Cover
26. Enclosure Cover
28. Wiring
30. Fluid Intake
33. Opening for Irrigation Control Plumbing
34. Opening for Lift-Off Cover
36. Exterior Wall
38. Manifold Extension
42. Lift-Off Cover
43. Enclosure Flange
45. Manifold
47. Manifold Flange
48. Manifold Hanger
49. Enclosure Flange
62. Water Lines
65. Manifold Bracket
110. Primary Elevated Irrigation Mounting System
112. Primary Manifold Bracket
116. Primary and Secondary Irrigation Control Unit
117. Primary Control Valve
118. Primary Enclosure
122. Primary Wiring Harness
130. Primary Fluid Intake
210. Secondary Elevated Irrigation Mounting System
212. Secondary Manifold Bracket
218. Secondary Enclosure
230. Secondary Fluid Intake
240. Secondary Mounting Surface
310. Elevated Irrigation Mounting System—3^{rd} Embodiment

1. An elevated irrigation mounting system for controlling the flow of fluid from a supply line to a plurality of outlet lines, said elevated irrigation mounting system comprising:
a fluid intake line;
a plurality of control valves;
a control unit actuating said plurality of control valves; and
a wiring harness being in electrical engagement with said plurality of control valves and said control unit; and
a manifold bracket to ensure sufficient spacing between said plurality of control valves, said manifold bracket enabling any of said plurality of control valves to be removed without interfering with an adjacent control valve, said wiring harness extending through said manifold bracket to said plurality of control valves, said manifold bracket including a manifold cover to protect said plurality of control valves and said wiring harness, said manifold bracket including a manifold top, said manifold bracket with said manifold top protecting said plurality of control valves and at least a portion of said wiring harness from dampness and animals; and
an enclosure having an open position and a closed position, said plurality of control valves being mounted within said enclosure such that said enclosure top protects said plurality of control valves and at least a portion of said wiring harness from dampness and animals; and
whereby said elevated irrigation mounting system is mountable above ground, onto an exterior structure enabling accessibility for repairs, calibration, and maintenance without needing to gain access to a residence or building.

2. The elevated irrigation mounting system of claim 1, wherein said elevated irrigation mounting system enables said plurality of control valves and said control unit to be prewired with a specific wiring harness that uses weather proof or non-weather proof connectors and specific wiring protection and covering.

3. The elevated irrigation mounting system of claim 1, further comprising an enclosure mounting flange secured to said enclosure, said enclosure mounting flange enabling said enclosure to be secured onto said exterior wall.

4. The elevated irrigation mounting system of claim 3, wherein a bottom surface of said mounting bracket includes a mounting notch, said mounting notch enabling said mounting bracket to be mounted against said enclosure flange, said mounting bracket and said enclosure being securely positioned onto said exterior structure.

5. The elevated irrigation mounting system of claim 1, wherein said manifold bracket includes a manifold flange and manifold flange openings, said mounting flange and manifold flange openings enabling said manifold bracket to be secured onto said enclosure mounting flange or onto said exterior surface.

6. The elevated irrigation mounting system of claim 1, wherein said enclosure includes an opening for a manifold bracket lift-off cover, said lift-off cover enabling access to said manifold without opening a top of said enclosure.

7. The elevated irrigation mounting system of claim 1, further comprising an enclosure having an open position and a closed position, said enclosure including an enclosure top, said enclosure having an enclosure flange, said enclosure flange having a plurality of enclosure flange apertures extending about portions of an enclosure perimeter.

8. The elevated irrigation mounting system of claim 7, further comprising a manifold flange extending about portions of a manifold flange perimeter, said manifold bracket including a plurality of mounting apertures for mounting a fastener for securing said manifold flange to an enclosure flange securely, said manifold flange apertures aligning with said enclosure flange apertures enabling said manifold bracket to be secured onto said enclosure flange or onto said exterior surface.

9. The elevated irrigation mounting system of claim 1, further comprising a secondary irrigation unit including a secondary enclosure having an open position and a closed position, said enclosure including an enclosure top; a secondary fluid intake line; a plurality of secondary control valves; a secondary wiring harness being in electrical engagement with said plurality of secondary control valves and said control unit; and a secondary manifold bracket to ensure sufficient spacing between said plurality of secondary control valves, said secondary manifold bracket enabling any of said plurality of secondary control valves to be removed without interfering with an adjacent secondary control valve, said secondary wiring harness extending through said secondary manifold bracket to said plurality of secondary control valves, said secondary manifold bracket including a secondary manifold cover to protect said plurality of secondary control valves and said secondary wiring harness, said manifold bracket including a secondary manifold top, said secondary manifold bracket with said secondary manifold top protecting said plurality of secondary control valves and at least a portion of said wiring harness from dampness and animals.

10. An elevated irrigation mounting system for controlling the flow of fluid from a supply line to a plurality of outlet lines, said elevated irrigation mounting system comprising:
a fluid intake line;
a plurality of control valves;
a control unit actuating said plurality of control valves; and
a wiring harness being in electrical engagement with said plurality of control valves and said control unit; and
a manifold hanger to ensure sufficient spacing between said plurality of control valves, said manifold hanger enabling any of said plurality of control valves to be removed without interfering with an adjacent control valve, said wiring harness extending through said manifold hanger to said plurality of control valves, said manifold hanger having a manifold flange extending about a surface of said manifold hanger, said manifold hanger flange including a plurality of mounting apertures;
an enclosure having an open position and a closed position, said enclosure including an enclosure top, said enclosure having an enclosure flange, said enclosure flange having a plurality of enclosure flange apertures extending about said enclosure perimeter, said enclosure flange apertures aligning with said manifold flange apertures enabling secure mounting of said enclosure onto an exterior surface;
said plurality of control valves being mounted within said enclosure such that said enclosure top protects said plurality of control valves and at least a portion of said wiring harness from dampness and animals; and
whereby said elevated irrigation mounting system is mountable above ground, onto a structure enabling accessibility for repairs, calibration or maintenance without needing to gain access to a residence or building.

11. The elevated irrigation mounting system of claim 10, further comprising a secondary irrigation unit including a secondary enclosure having an open position and a closed position, said enclosure including an enclosure top; a secondary fluid intake line; a plurality of secondary control valves; a secondary wiring harness being in electrical engagement with said plurality of secondary control valves and said control unit; and a secondary manifold hanger to ensure sufficient spacing between said plurality of secondary control valves, said secondary manifold hanger enabling any of said plurality of secondary control valves to be removed without interfering with an adjacent secondary control valve, said secondary wiring harness extending through said secondary manifold hanger to said plurality of secondary control valves, said secondary irrigation unit including a secondary enclosure and a secondary enclosure top, said secondary enclosure with said secondary enclosure top protecting said plurality of secondary control valves and at least a portion of said wiring harness from dampness and animals.

12. The elevated irrigation mounting system of claim 11, wherein a bottom surface of said mounting bracket includes a mounting notch, said mounting notch enabling said mounting bracket to be mounted against said enclosure flange, said mounting bracket and said enclosure being securely positioned onto said exterior structure.

13. The elevated irrigation mounting system of claim 11, wherein said manifold bracket includes a manifold flange and manifold flange openings, said mounting flange and manifold flange openings enabling said manifold bracket to be secured onto said enclosure mounting flange or onto said exterior surface.

14. The elevated irrigation mounting system of claim 11, wherein said enclosure includes an opening for a manifold bracket lift-off cover, said lift-off cover enabling access to said manifold without opening a top of said enclosure.

15. An elevated irrigation mounting system for controlling the flow of fluid from a supply line to a plurality of outlet lines, said elevated irrigation mounting system comprising:
a fluid intake line;
a plurality of control valves;
a control unit actuating said plurality of control valves, said control unit being in digital communication with at least one of said control valves; and
a manifold bracket to ensure sufficient spacing between said plurality of control valves, said manifold bracket enabling any of said plurality of control valves to be removed without interfering with an adjacent control valve, said manifold bracket including a manifold cover to protect said plurality of control valves, said manifold bracket including a manifold top, said manifold bracket with said manifold top protecting said plurality of control valves from dampness and animals; and
an enclosure having an open position and a closed position, said plurality of control valves being mounted within said enclosure such that said enclosure top protects said plurality of control valves from dampness and animals; and
whereby said elevated irrigation mounting system is mountable above ground, onto an exterior structure enabling accessibility for repairs, calibration, and maintenance without needing to gain access to a residence or building.

16. The elevated irrigation mounting system of claim 15, further comprising an enclosure mounting flange secured to said enclosure, said enclosure mounting flange enabling said enclosure to be secured onto said exterior wall.

17. The elevated irrigation mounting system of claim 16, wherein a bottom surface of said mounting bracket includes a mounting notch, said mounting notch enabling said mounting bracket to be mounted against said enclosure flange, said mounting bracket and said enclosure being securely positioned onto said exterior structure.

18. The elevated irrigation mounting system of claim 16, wherein said manifold bracket includes a manifold flange and manifold flange openings, said mounting flange and manifold flange openings enabling said manifold bracket to be secured onto said enclosure mounting flange or onto said exterior surface.

19. The elevated irrigation mounting system of claim 15, wherein said enclosure includes an opening for a manifold bracket lift-off cover, said lift-off cover enabling access to said manifold without opening a top of said enclosure.

20. The elevated irrigation mounting system of claim 15, further comprising a manifold flange extending about a manifold flange perimeter, said manifold bracket including a plurality of mounting apertures for mounting a fastener for securing said manifold flange to an enclosure flange securely, said manifold flange apertures aligning with said enclosure flange apertures enabling said manifold bracket to be secured onto said enclosure flange or onto said exterior surface.
